(19) United States
(12) Patent Application Publication
(10) Pub. No.: US 2025/0005319 A1
(43) Pub. Date: Jan. 2, 2025

(54) NEURAL NETWORK SPLITTER

(71) Applicant: STMicroelectronics International N.V., Geneva (CH)

(72) Inventors: Danilo Pietro Pau, Sesto San Giovanni (IT); Biagio MONTARULI, Ruvo di Puglia (IT); Andrea SANTAMARIA, CAMBIAGO (IT)

(21) Appl. No.: 18/214,897

(22) Filed: Jun. 27, 2023

(51) Int. Cl. G06N 3/04; G06N 3/10

(52) U.S. Cl. CPC G06N 3/04; G06N 3/10

(57) ABSTRACT

Methods, apparatuses, systems, and/or computer program products for using a neural network splitter to split a neural network into slices are provided. A splitter device may receive a neural network. The splitter devices may be connected to one or more other devices. The neural network may be split the neural network into slices to be deployed to the one or more other devices for execution. The neural network splitter may generate and intermediate representation of the neural network. A profiler of the neural network splitter may extract one or more features from the intermediate representation. A classifier may select one or more heuristics of the neural network features. The neural network may then determine one or more slices based on the features, heuristics, and device characteristics of the connected devices. The slices may be generated and deployed to the connected devices for execution.

### TECHNOLOGICAL FIELD

Example embodiments of the present disclosure relate generally to neural networks and machine learning, and more particularly to a neural network splitter used in methods, apparatuses, systems, and/or computer program products.

### BACKGROUND

Neural networks are machine learning algorithms created for various applications, such as image identification, language processing, etc. Creating a neural network takes time and resources to design, train, and/or certify performance of the neural network. This is increasingly being performed in general without regard to the specific device(s) that may execute the neural network. Moreover, many neural networks are too complex to be run on resource constrained (e.g., tiny) devices.

New methods, apparatuses, systems, and computer programming products in neural networks and machine learning are needed. The inventors have identified numerous areas of improvement in the existing technologies and processes, which are the subjects of embodiments described herein. Through applied effort, ingenuity, and innovation, many of these deficiencies, challenges, and problems have been solved by developing solutions that are included in embodiments of the present disclosure, some examples of which are described in detail herein.

### BRIEF SUMMARY

Various embodiments described herein relate to neural networks and machine learning, and more particularly to a neural network splitter used in methods, apparatuses, systems, and/or computer program products.

In accordance with some embodiments of the present disclosure, an example method is provided. The example method may comprise: generating an intermediate representation of a neural network, wherein the neural network is comprised of a plurality of layers; extracting, via a profiler of a splitter device, a plurality of neural network features based on the intermediate representation; selecting, via a classifier of the splitter device, one or more heuristics based on the neural network features; determining one or more device characteristics of the one or more devices, wherein the one or more devices are connected to the splitter device; determining a plurality of slices based on the neural network features, the one or more heuristics and the device characteristics, wherein each slice of the plurality of slices is associated with at least one of the devices, and wherein each of the plurality of slices is associated with one or more of the plurality of layers; and generating the plurality of slices.

In some embodiments, the method further comprises transmitting each of the plurality of slices to the associated device of the one or more devices.

In some embodiments, the classifier is comprised of a classifier neural network.

In some embodiments, determining one or more device characteristics of the one or more devices comprises: querying the one or more connected devices; and receiving, based on the query, the device characteristics.

In some embodiments, the one or more devices are heterogenous devices.

In some embodiments, the one or more heuristics includes minimizing a latency.

In some embodiments, the one or more heuristics includes maximizing a throughput.

In some embodiments, each slice of the plurality of slices is associated with only one device.

In some embodiments, at least two of the slices of the plurality of slices are associated with a first device of the one or more devices.

In some embodiments, the slices are comprised of instructions for transmitting results associated with an execution of slice to a subsequent device.

In accordance with some embodiments of the present disclosure, an example splitter device is provided. The splitter device may be comprised of at least one processor and at least one memory coupled to the processor, wherein the processor is configured to: generate an intermediate representation of a neural network, wherein the neural network is comprised of a plurality of layers; extract, via a profiler of the splitter device, a plurality of neural network features based on the intermediate representation; select, via a classifier of the splitter device, one or more heuristics based on the neural network features; determine one or more device characteristics of the one or more devices, wherein the one or more devices are connected to the splitter device; determine a plurality of slices based on the neural network features, the one or more heuristics and the device characteristics, wherein each slice of the plurality of slices is associated with at least one of the devices, and wherein each of the plurality of slices is associated with one or more of the plurality of layers; and generate the plurality of slices.

In some embodiments, the processor is further configured to: transmit each of the plurality of slices to the associated device of the one or more devices.

In some embodiments, the classifier is comprised of a classifier neural network.

In some embodiments, to determine one or more device characteristics of the one or more devices the processor is further configured to: query the one or more connected devices; and receive, based on the query, the device characteristics.

In some embodiments, the one or more devices are heterogenous devices.

In some embodiments, the one or more heuristics includes minimizing a latency.

In some embodiments, the one or more heuristics includes maximizing a throughput.

In some embodiments, each slice of the plurality of slices is associated with only one device.

In some embodiments, at least two of the slices of the plurality of slices are associated with a first device of the one or more devices.

In some embodiments, the slices are comprised of instructions for transmitting results associated with an execution of slice to a subsequent device.

The above summary is provided merely for the purpose of summarizing some example embodiments to provide a basic understanding of some aspects of the disclosure. Accordingly, it will be appreciated that the above-described embodiments are merely examples and should not be construed to narrow the scope or spirit of the disclosure in any way. It will also be appreciated that the scope of the disclosure encompasses many potential embodiments in addition to those here summarized, some of which will be further described below.

### BRIEF SUMMARY OF THE DRAWINGS

Having thus described certain example embodiments of the present disclosure in general terms, reference will now be made to the accompanying drawings, which are not necessarily drawn to scale

FIG. 1 illustrates an example block diagram of an environment including a neural network splitter in accordance with one or more embodiments of the present disclosure.

FIG. 2 illustrates an example block diagram of a first plurality of devices executing a plurality of slices of a neural network in accordance with one or more embodiments of the present disclosure.

FIG. 3 illustrates an example block diagram of a second plurality of devices executing a plurality of slices of a neural network in accordance with one or more embodiments of the present disclosure.

FIG. 4 illustrates an exemplary flowchart for using neural network splitter in accordance with one or more embodiments of the present disclosure.

FIG. 5 illustrates an exemplary flowchart for splitting a neural network in accordance with one or more embodiments of the present disclosure.

FIG. 6 illustrates an exemplary flowchart for determining slices in accordance with one or more embodiments of the present disclosure.

FIG. 7 illustrates an example block diagram of a device in accordance with one or more embodiments of the present disclosure.

### DETAILED DESCRIPTION

Some embodiments of the present disclosure will now be described more fully herein with reference to the accompanying drawings, in which some, but not all, embodiments of the disclosure are shown. Indeed, various embodiments of the disclosure may be embodied in many different forms and should not be construed as limited to the embodiments set forth herein; rather, these embodiments are provided so that this disclosure will satisfy applicable legal requirements. Like reference numerals refer to like elements throughout.

As used herein, the term “comprising” means including but not limited to and should be interpreted in the manner it is typically used in the patent context. Use of broader terms such as comprises, includes, and having should be understood to provide support for narrower terms such as consisting of, consisting essentially of, and comprised substantially of.

The phrases “in various embodiments,” “in one embodiment,” “according to one embodiment,” “in some embodiments,” and the like generally mean that the particular feature, structure, or characteristic following the phrase may be included in at least one embodiment of the present disclosure and may be included in more than one embodiment of the present disclosure (importantly, such phrases do not necessarily refer to the same embodiment).

The word “example” or “exemplary” is used herein to mean “serving as an example, instance, or illustration.” Any implementation described herein as “exemplary” is not necessarily to be construed as preferred or advantageous over other implementations.

If the specification states a component or feature “may,” “can,” “could,” “should,” “would,” “preferably,” “possibly,” “typically,” “optionally,” “for example,” “often,” or “might” (or other such language) be included or have a characteristic, that a specific component or feature is not required to be included or to have the characteristic. Such a component or feature may be optionally included in some embodiments, or it may be excluded.

The use of the term “circuitry” as used herein with respect to components of a system or an apparatus should be understood to include particular hardware configured to perform the functions associated with the particular circuitry as described herein. The term “circuitry” should be understood broadly to include hardware and, in some embodiments, software for configuring the hardware. For example, in some embodiments, “circuitry” may include processing circuitry, communications circuitry, input/output circuitry, and the like. In some embodiments, other elements may provide or supplement the functionality of circuitry.

### Overview

Various embodiments of the present disclosure are directed to improved methods, apparatuses, systems, and/or computer program products using neural networks and machine learning, and more particularly to a neural network splitter.

Neural networks are machine learning algorithms created for various applications. Neural networks include various topologies that may connect a plurality of nodes by using operations, weights, biases, and the like. The neural network topology may be divided into a plurality of layers that are executed sequentially and/or in parallel to execute the machine learning algorithm. The neural network may be trained on various datasets to get the neural network to generate a specific output based on certain input(s). The creation of neural networks is increasingly being performed without regard to the specific device(s) that will execute the neural networks. For example, the neural networks disregard the computational resources one or more devices may have to execute the neural network. An example of a type of neural network is a Deep Neural Network (DNN), which achieves significant accuracy at high computational resource cost (e.g., memory, computation etc.). Neural networks, including DNNs, may be deployed to and executed or run on devices that are not optimized nor meant for such a neural network. Additionally, after a neural network is created, redesign of the neural network may not be done for specific devices and/or device hardware that would execute the neural network, particularly when neural networks are rolled out to new devices that may be added later. This may be due to the neural network architect or designer not knowing the device(s) used or to be used to execute the neural network.

The use of a neural network splitter as described herein may allow for, among other things, improved implementation, execution, and/or deployment of one or more neural networks across on or to one or more devices.

A neural network may be implemented and/or executed on one or more devices, which may be homogeneous or heterogenous regarding their computational resources and/or their execution of the neural network(s), such as one or more slices. Each device may contain one or more processors, memory, more or less computing power, energy consumption, etc. for executing the neural network or a portion of the neural network, but the devices and/or circuitry of the device may or may not be the same. The processors and/or memories between devices may be different, particularly where devices available may be different. Each device may be connected to transmit and/or receive data from a splitter device with different communication circuitry and across different network connections. A neural network to be executed may be deployed to the different devices based on one or more characteristics associated with the device to improve execution of the neural network. For example, a first device may be a sensor with comparatively low computational resources (e.g., processor speed, memory capacity, etc.). A second device may be a microcontroller, server, tablet, or laptop that has incrementally and/or comparatively higher computational resources (e.g., processor speed, memory capacity, etc.). Another example may include a single device having multiple heterogenous processors, each of which may be sed separately. Alternatively, or additionally, a plurality of devices may be networked that may have homogenous and/or heterogenous computational resources (e.g., processors, memories, networking circuitry, etc.). In various embodiments, each device may have the same, similar, and/or different characteristics and/or be implemented with different capacities.

In accordance with the present disclosure, a neural network splitter may split a neural network into one or more slices or portions to be executed by one or more devices. Each slice of the neural network may include one or more layers associated with the neural network. The split of the neural network into slices may be based on the devices and/or the layers in one or more slices. For example, slice(s) and an associated device(s) to execute the slice(s) may be based on the computational resources required to execute the layer(s) of the slice(s) and/or the computational resources of the device(s) that the slice(s) is assigned to for execution.

The neural network splitter may split one or more neural networks based on one or more constraints, targets, thresholds, or the like. For example, a target may be a target execution time, a target throughput, power consumption, overall bill of material, a target number of processors (e.g., microcontrollers, etc.). Combinations of targets may be used, including prioritizing the targets to achieve a first target first (e.g., prioritize latency and then prioritize throughput). In various embodiments, the targets may be associated with one or more of the devices to execute a slice, such as when a slice may be scheduled for execution during a period when a device(s) may be free or otherwise not occupied.

A neural network splitter may include, among other things, a profiler and a classifier. The profiler may extract one or more neural network features from an intermediate representation of a neural network. Neural network features may include a number and/or type of neural network function described herein and/or computational resources required for execution of such a function. The intermediate representation may be distinct from the neural network 200. The classifier may be a classifier neural network that is trained to generate and/or identify a set or subset of heuristics. The classifier neural network may be a neural network different from the neural network being split by the neural network splitter. For example, the classifier neural network may be trained on different data with respect to the data of the neural network being split. In some embodiments, the data the classifier neural network may be trained on may be statistics associated with past splitting of other neural networks. Based on the output of the profiler and classifier along with device information that may be known and/or received, the neural network splitter may determine how to split a neural network received by the neural network splitter and generate a plurality of slices of the neural network for execution by one or more devices.

For example, the neural network splitter may map a pre-trained and arbitrarily complex DNN to a plurality of slices for a plurality of heterogeneous devices. Thus, the neural network splitter may optimize execution of the neural network for execution based on one or more targets, such as the total inference latency, throughput, etc. Moreover, the neural network splitter tunes the slices so that they are compatible with the computational resources and/or computational constraints of the device(s) executing the neural network.

Example targets may include total inference latency and total throughput.

Total inference latency may include total computational latency, total communication latency, power consumption, cost, etc.

Computation latency may include the sum of the computation latencies for all the assigned devices to execute the assigned layers in the assigned slice(s). The computational latency for a particular device may be the sum of latencies in executing each layer. For example, a layer computational latency may include the MACC times the CpM, or cycles per MACC (e.g., the average number of clock cycles for a single MACC operation for the device), divided by the CPU frequency or clock frequency of the device.

Computation communication latency may include the sum of the communication latencies to transmit and/or receive information between one or more of the devices.

Throughput may be the inverse of the waiting time for the devices to execute assigned slices. The waiting time may be the sum of the highest (i.e., maximum) computational latency, the communication latency, and the intermediate computational latency not associated with the highest computational latency.

The slices of the neural network may be transmitted to the associated and/or assigned devices to be executed. The slices may be transmitted and/or deployed in series and/or parallel. For example, after the execution of a first slice by a first device is complete, the results may be transmitted to a second device or, if there are no further slices to execute, to the splitter device and/or another result device.

Thus the neural network splitter may automatically partition a neural network received by the neural network splitter over a plurality of devices while preserving the performance and the accuracy of the neural network and/or also satisfying one or more target constraints.

It should be readily appreciated that the embodiments of the methods, apparatuses, systems, and computer programming products described herein may be configured in various additional and alternative manners in addition to those expressly described herein.

### Exemplary Systems and Apparatuses

Embodiments of the present disclosure herein include methods, systems, apparatuses, and computer program products for a neural network splitter.

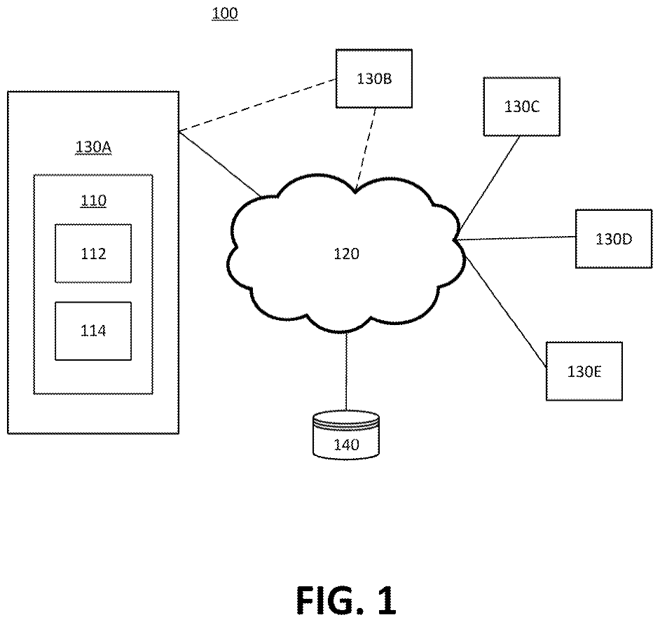

FIG. 1 illustrates an example block diagram of an environment with a neural network splitter in accordance with one or more embodiments of the present disclosure.

An environment 100 may include a plurality of devices 130. The devices 130 may be directly connected (e.g., 130A to 130B) and/or remotely connected over a network 120. A device 130 (e.g., 130A) may include neural network splitter 110. In various embodiments, the neural network splitter 110 may include a profiler 112 and/or a classifier 114. Alternatively, the neural network splitter 110 may be included in a system and/or apparatus connected to one or more devices, which may be incorporated and/or included in the system and/or apparatus.

The neural network splitter 110 may split a neural network into one or more slices. A slice may contain one or more layers of the neural network. The slices may be transmitted, distributed, and/or deployed to one or more devices 130. The one or more devices 130 may execute the slices. The neural network splitter 110 may determine the slices and how to deploy the slices to the devices 130. This determination may be based on the characteristics of device 130, including but not limited to computational resources (e.g., processor(s), memory(ies), power consumptions(s), etc.).

In various embodiments, one or more devices (e.g., 130B) may have the same characteristics of one or more other devices (e.g., 130C-130D). Alternatively, or additionally, one or more device (e.g., 130B) may have different characteristics from one or more other devices (e.g., 130C-130D). The neural network splitter 110 may determine how many slices to generate as well as how to deploy the slices based on one or more characteristics of the device(s) 130.

In various embodiments, one or more of the devices 130 may include one or more microcontrollers, such as used in a distributed network of sensors. One or more of the microcontrollers may be directly connected to the neural network splitter 110 and one or more additional microcontrollers may be connected over a network 120. The neural network may be slied by the neural network splitter into a plurality of slices that may be executed by the sensors.

In various embodiments, one or more of the devices 130 may include one or more cloud devices, mobile devices, or edge devices, such as used in a distributed telecommunication network. One or more of the cloud devices, mobile devices, or edge devices may be connected to the neural network splitter 110 over a telecommunication network 120. The neural network may be sliced by the neural network splitter into a plurality of slices that may be executed by the cloud devices, mobile devices, or edge devices. This may include the neural network being sliced by the neural network splitter 110 into a plurality of slices that may be executed on a mix of cloud devices, mobile devices, and/or edge devices.

The neural network splitter 110 may access or query the device characteristics from one or more memories, servers, databases 140, and/or devices 130 connected and accessible to the neural network splitter 110. For example, the neural network splitter 110 may query one or more devices (e.g., 130B-130E) to determine the device characteristics associated with each connected device by receiving a response transmitted from the one or more device 130 in response to the query(ies). For example, each device 130 may be queried and transmit device characteristics in response to the query. Additionally, or alternatively, each device may transmit in return device identification information that may be used to query a device database 140. Device database 140 may include device characteristics and in response to the query may transmit the device characteristics associated with device identifications to the neural network splitter 110.

The device characteristics are associated with the different characteristics of a device, such as computation resources (e.g., processor(s), memory(ies), power consumption(s), etc.). The device characteristics may be accessed for use in determining and/or generating slices. For example, a device may have one or more processors, one or more RAM, and one or more FLASH memories, different power consumptions, clock frequency, computational power, etc. Each of such processors, RAM, FLASH memories may be associated with different characteristics, such as memory size, processing capacity (e.g., CPU clock frequency, cycles per MAC, etc.) and/or the like. Additionally, and/or alternatively, each device (e.g., 130B-130E) may be connected to the neural network splitter 110 through a different connection and, thus, may have a different connection latency as well as connection throughput. Moreover, different types of connections, including one or more protocols used by the connection(s), may impact the connection characteristics. It will be appreciated that such connection characteristics are based on the connection, which are part of the device's computational characteristics described herein used by the neural network splitter 110.

The neural network splitter 110 may be run online or may be run offline. In some embodiments, running online may use the neural network splitter 110 to split a neural network and provide the slices for execution in real-time or near real-time. In some embodiments, running offline may use the neural network splitter 110 to split a neural network into slices for execution at a later time.

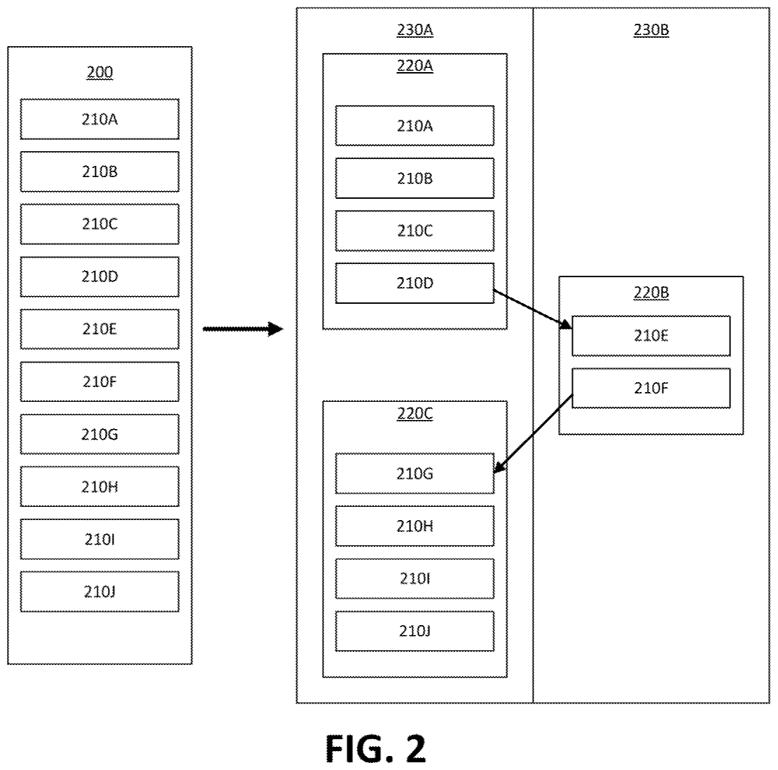

FIG. 2 illustrates an example block diagram of a first plurality of devices executing a plurality of slices in accordance with one or more embodiments of the present disclosure.

A neural network 200 may be comprised of a plurality of layers 210A-210J. The neural network may be received by the neural network splitter 110. The neural network splitter 110 may generate a plurality of slices. For example, the plurality of layers 210A-210J may be assigned to a plurality of slices, such as slices 220A-220C. Each of the slices 220A-220C may be comprised of different layers of the neural network 200. Slice 220A may include layers 210A-210D, slice 220B may include layers 210E, 210F, and slice 220C may include layers 210G-210J.

Each layer 210 may be associated with one or more functions of the neural network 200, including but not limited to convolutions, dense, recurrencies, math operations (e.g. ADD etc.), concatenations, attention mechanisms, transformations, reshape, allocators of neurons, tensor manipulations, split, joins nodes, residuals, nonlinearity, etc. For example, the layers 210 are associated with the functions to be executed for performance of the machine learning algorithm that is the neural network 200. The neural network 200 may be broken into a plurality of slices 220 with each slice associated with one or more layers 210. Each layer 210, and thus each slice 220, is also associated with one or more layer characteristics, such as required computation resources (e.g., memory size (e.g., RAM size, FLASH (ROM) size), and/or multiply-accumulate (MAC) operations, etc.). Slice characteristics are the collective layers characteristics of the one or more layers 210 of a slice 220. These layer characteristics may be associated and/or mapped to one or more devices 230 based on the device characteristics.

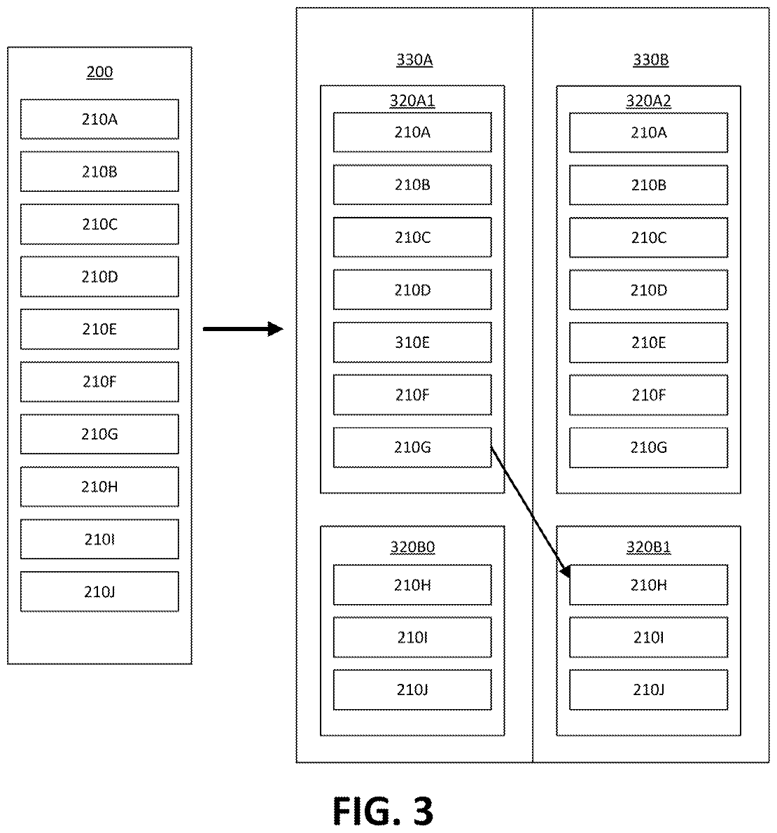

In various embodiments, the neural network splitter 110 may generate slices 220 to use the fewest number of devices 230 as possible. Alternatively or additionally, the neural network splitter 110 may generate slices 220 based on the time to execute the neural network 200. For example, the layers 210 to assign each slice 220 may be assigned based on the speed with which the slice(s) 220 may be executed by one or more of the device(s) 230 to which a slice 220 may be assigned. Alternatively, or additionally, such as illustrated in FIG. 3, the slices 320 may be assigned so that specific devices 330 may execute the same slice 320 iteratively and/or in parallel with slices 320 that may be assigned to another specific device(s) 330.

As illustrated in FIG. 2, the slices 220A-220C may be deployed to one or more devices 230. For example, there may be two devices 230A and 230B. Device 230A may receive and execute slice 220A and slice 220C. Device 230B may receive and execute slice 230B. The layers 210 of the neural network 200 may be executed in series and/or parallel. In FIG. 2, the layers 210A-210D may be executed by device 230A. Then device 230A may transmit the result of layer 210D to device 230B. Device 230B may execute layers 210E, 210F before transmitting the results of layer 210F to device 230A. Device 230A may receive the results of layer 210F from device 230B and execute layers 210G-210J of slice 220C. After completion of the last slice of a neural network (e.g., slice 220C), the device executing the last slice (e.g., device 230A) may transmit and/or return the results of the last slice to the neural network splitter circuitry 110. Transmission of the slices, results, and/or other data between devices and/or across a network may be via one or more data objects containing the slices, results, and/or other data. An example of the other data may include but is not limited to data required to direct and/or track where a slice has been transmitted from and where the results of an executing a slice may need to be transmitted to.

In FIG. 2, device 230A and device 230B execute the slices in a sequential order. It will be appreciated that one or more devices 230 may be used to execute the slices 220 associated with a neural network 200. The devices may execute layers 210 of a slice 220 and transmit the results of the last layer 210 of a slice 220 to the next device 230 and/or to the neural network splitter circuitry 110.

In various embodiments, the execution of layers 210 of the slices 220 may be scheduled for execution by a device 230 and/or executed once received. A device 230 may execute one or more layers 210 in parallel.

FIG. 3 illustrates an example block diagram of a second plurality of devices executing a plurality of slices in accordance with one or more embodiments of the present disclosure.

A neural network 200 may be comprised of a plurality of layers 210A-210J. The plurality of layers 210A-210J may be assigned to a plurality of slices 320, such as slices 320A, 320B. Each of the slices 320A, 320B may be comprised of different layers of the neural network 200. For example, slice 320A may include layers 210A-210G and slice 320B may include layers 210H-210J. Additionally, multiple iterations of the neural network may be executed such that there is a slice 320A0, 320A1, and a slice 320A2 as well as a slice 320B0, 320B1, and slice 320B2 that may be run on separate devices 330. It will be appreciated that while only two devices are illustrated that there may be additional devices, such as a device associated with a related slice 320A0, slice 320B2, and so on.

The slices 320A1, 320A2, 320B0, and 320B1 may be deployed to one or more devices 330. In an embodiment illustrated in FIG. 3, there may be two devices 330A, and 330B. Device 330A may receive slices 320A1 and 320B0, which may be received and executed at different times and in series. Similarly, device 330B may receive slices 320A2 and 320B1.

Device 330A may receive slice 320A1 and then slice 320B0. The layers 210 of the neural network 200 may be executed in series and/or parallel. As illustrated in FIG. 3, the layers of slice 320A1 are executed by device 330A in parallel with the execution of the layers of slice 320A2 by device 330B. The devices 330 may transmit the results of the last layer executed to an associated device that will execute the next layer that is in a next slice and/or may transmit the results of the last layer of a last slice to the neural network splitter 110.

It should be readily appreciated that the embodiments of the systems and apparatuses described herein may be configured in various additional and alternative manners in addition to those expressly described herein.

### Exemplary Methods

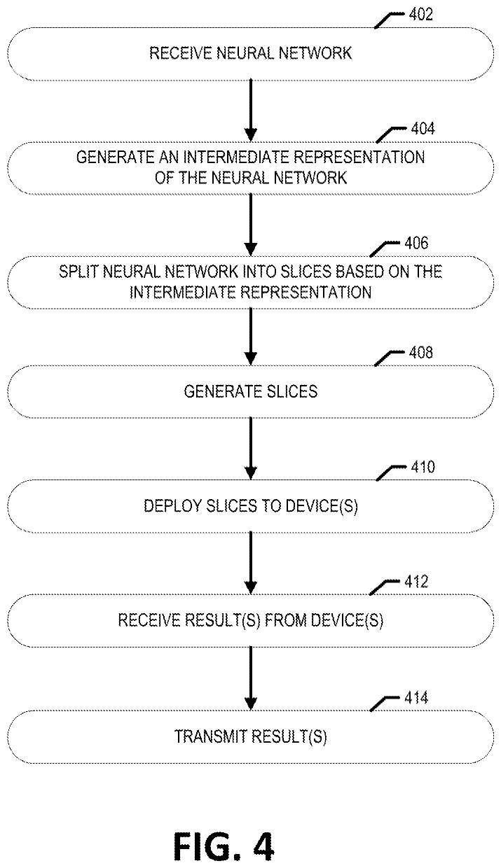

FIG. 4 illustrates an exemplary flowchart for using neural network splitter in accordance with one or more embodiments of the present disclosure.

At operation 402, the neural network is received. A neural network 200 may be transmitted to a device 130 with neural network splitter 110. The neural network 200 may be received from a user and/or load based on an instruction received from a user. For example, a user may send the neural network 200 or an instruction from another device 130, which may then be loaded from memory or from a database 140. The neural network may be transmitted in a first format. The format may be based on the coding of the neural network. For example, the neural network format may be, but is not limited to, Keras, QKeras, Larq, JSON, ONNX, TensorFlow Lite, Pytorch, MXNet, PaddlePaddle, etc.

At operation 404, generate an intermediate representation of the neural network. The intermediate representation of the neural network 200 received may be generated by importing the neural network 200 and converting it to an intermediate representation. This may include converting or translating the neural network 200 from a first format to a second format. The second format may use a different coding language than the first format. For example, the second format may be C code, xml, JSON, or another format utilized by one or more devices 130.

In various embodiments, the intermediate representation may be generated by performing multiple iterations of one or more operations on the neural network 200 received. The iterations may be based on, for example, the topology of neural network 200 received. For example, the iterations may include analyzing, optimizing, allocating, and generating instances generating inferences from the neural network 200.

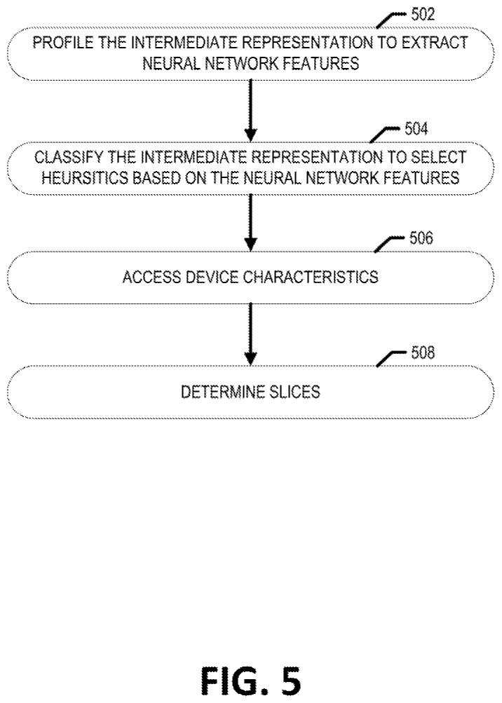

At operation 406, split the neural network into a plurality of slices. The neural network splitter 110 may split the neural network 200 into a plurality of slices (e.g., 220, 320), which is described further herein, including but not limited to as described in relation to FIG. 5.

At operation 408, the slices are generated. After the number of slices and the layers to include in each slice are determined, the slices are generated. Generating the slices may include generating one or more slice files, which may be executable slice file(s) and/or data objects associated with each slice. For example, a plurality of C code slice files may be generated for executing the plurality of slice on one or more associated device(s).

In various embodiments, the slices, including the slice files, may be generated in different formats, which may be based on the specific device that a slice is to be deployed to. The formats of the one or more slices may be based on or specific to a processor of a device 130 that may execute a particular slice file. For example, a first slice file associated with a first device may be coded in a first format associated with the first device, a second slice file associated with a second device may be coded in a second format, and so on.

At operation 410, the slices are deployed. The slices may be deployed to the associated devices 130. Slices associated with a directly connected device may be transmitted from a splitter device (e.g., 130A) to the associated directly connected device (e.g., 130B). Similarly, slices associated with a remotely connected device (e.g., 130C) over a network 120 may be transmitted over the network 120. The slices may be deployed so that they may be executed by the respective devices (e.g., 130C).

The slices may include, such as in a slice files or associated data object, how the results of the first slice from a first device should be transmitted to the next device to process the next slice and so on until the results of the execution of the slices are transmitted to the neural network splitter 110. For example, a slice may be executable C code or an interpreted language (e.g., Python).

At operation 412, results from the executed slices are received. After execution of the plurality of slices associated with a neural network 200, the results of the execution of the slices and, thus, the neural network 200, are transmitted to the neural network splitter 110.

At operation 414, the results of the neural network are transmitted to a user. The result so the neural network 200, particularly of the execution of the slices of the neural network 200, are transmitted by the neural network circuitry to the user. In various embodiments, transmitting the results of the neural network 200 to a user may include transmitting one or more data objects across a network 120 to a user device 130. Alternatively, and/or additionally, transmitting the results of the neural network 200 to a user may include rendering the results on a display, such as a desktop computer, or generating an file to render the results on a remote display, such as a mobile device, laptop computer, and the like, which may be transmitted via the network 120.

FIG. 5 illustrates an exemplary flowchart for splitting a neural network in accordance with one or more embodiments of the present disclosure.

To split a neural network 200 for execution on one or more devices 130, the computations requirements of the layers 210 deployed to a device 130 may be equal to or less than the device characteristics of the associated device 130. For a neural network 200 to be deployed to a plurality of devices 130, the sum of the neural network computational resources of the devices 130 are equal to or greater than the computational requirements and/or neural network features required by the neural network 200. For example, the total FLASH size required to execute the neural network 200 may be less than or equal to the sum of the devices' FLASH sizes. As another example, the max RAM size of the neural network 200 may be less than or equal to the sum of the available devices' RAM sizes.

The features or computational requirements of a neural network 200 may be extracted by a profiler 112 of a neural network splitter 110 based on an intermediate representation of the neural network 200. To determine the slices, a classifier 114 of the neural network splitter 110 may classify the intermediate representation by implementing one or more branch and bound operations that may determine the distribution of slices as a constraint satisfaction optimization problem (CSOP), which may find a best solution. The branch and bound operations may be optimized through one or more heuristics that allow for finding an optimal solution based on device characteristics. Classifier 114 may be a neural network that has been trained to automatically optimize the determination of the plurality of slices based on the one or more devices 130 to execute the slices.

At operation 502, profile the intermediate representation. Profiling the intermediate representation may be performed by the profiler 112. Profiling the intermediate representation may include determining the computation complexity of the intermediate representation, including for each layer. The computation complexity determined may include the number of multiplications, additions, maximum, standard deviations, etc. associated with each layer. Each computational operation may be associated with one or more characteristics, including memory requirements and/or processing requirements. Profiling may include aggregating the features.

The profiling circuitry may profile the neural network received to extract and/or determine one or more features that may synthesize the computational complexity for a neural network received, including the layers of the neural network received.

The features may include but are not limited to topology features, computational complexity features, memory (RAM) features, memory (ROM) features, and the like. The topology features may include the depth of the neural network received, iterations of nodes, and the like. The computational complexity features may include MACC mean, MACC standard deviation, max MACC, min MACC, and the like. Memory (RAM) features may include RAM mean, RAM standard deviation, max RAM, min RAM, and the like. Memory (ROM) features may include FLASH mean, FLASH standard deviation, max FLASH, min FLASH, and the like. The features may also include one or more target heuristics to optimize. Additionally, or alternatively, layers of the neural network received may be profiled, including but not limited to dividing layers into a plurality of disjointed consecutive intervals and, for each one, determining features.

At operation 504, classify the intermediate representation to select heuristics based on the neural network features. The selected heuristics may be targets. Classifying the intermediate representation may be performed by classifier 114. The classifier 114 may be a neural network (referred to herein as the classifier neural network) that has been trained to classify intermediate representations of a neural network 200 to select heuristics based on the neural network features extracted by the profiler 112. The classifier 114 may be trained offline on a plurality of neural networks 200. The classifier 114 may identify one or more heuristics. The heuristics may be to improve speed, throughput, and/or reaching the optimal decomposition (e.g., max ram, max frequency, etc.). In various embodiments, the classifier 114 may identify one or more heuristics associated with a target or constraint that may optimize the execution of the neural network. In various embodiments selecting multiple heuristics, the classifier 114 may prioritize the heuristics into a heuristic order, with a first heuristic in the heuristic order to be optimized first, a second heuristic in the heuristic order to optimized second, and so on.

At operation 506, device characteristics may be determined. Device characteristics of devices 130 may be determined based on information known to splitter device 130A. Alternatively or additionally, the splitter device 130A may query the connected devices and/or one or more databases 140 for device characteristics. In various embodiments, accessing device characteristics may be performed prior to or in parallel of operations 502 and/or 504.

For example, a network 120 may be established prior to the neural network 200 being received by the neural network splitter 110. The network 120 may be known to the splitter device 130A, which may include the splitter device 130 having device characteristics of the connected devices 130 stored in memory. The splitter device 130A may query its memory to determine the device characteristics.

In another example, the splitter device 130A may query connected devices 130 over the network 120. Each device 130 connected through the network 120 may respond with a device identifier and/or device characteristics. The device identifier may include a unique identifier and/or identification of the hardware and/or circuitry of the device 130, including but not limited to a processor identification, memory identification, and the like. In various embodiments, based on the unique identifier and/or the identification of hardware and/or circuitry, the splitter device 130A may query a database 140. Thus, the splitter device 130A may receive the device characteristics from a connected device 130 and/or a database 140.

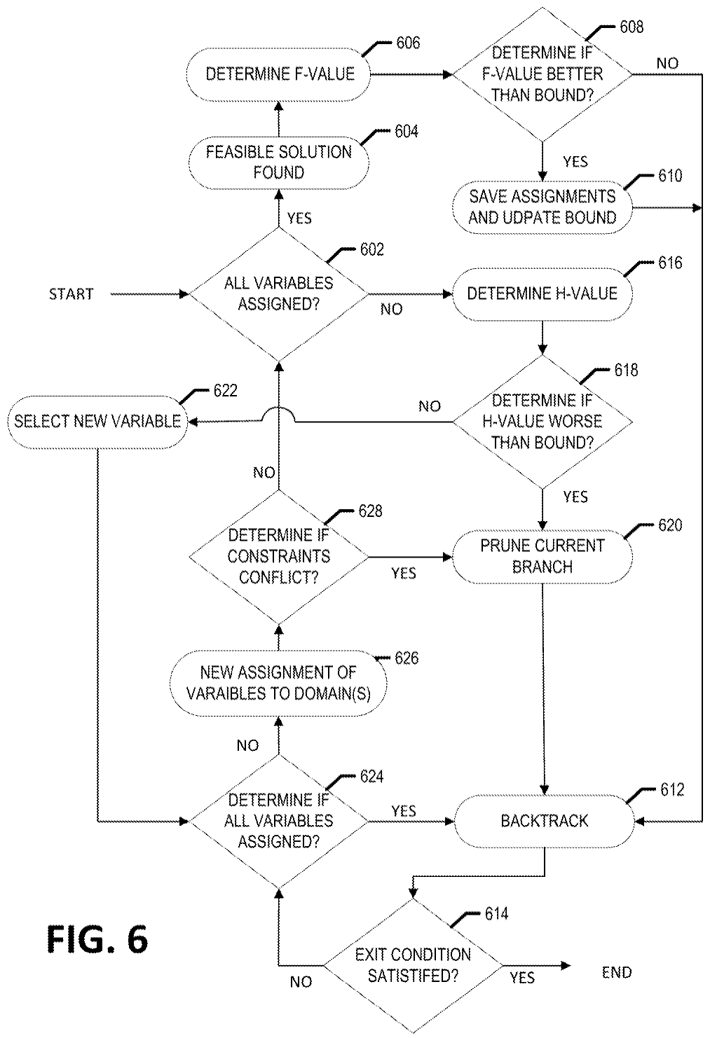

At operation 508, the slices are determined. The neural network splitter 110 may determine one or more slices based on the neural network features, the heuristics, and/or the device characteristics. Operations associated with determining the slices are further described herein in, such as in relation to FIG. 6.

For example, based on the heuristics classified and/or selected by the classifier 114 and the device characteristics, one or more branch and bound operations may determine slices based on a search space of all possible combinations of layers assigned to available devices 130, which may be referred to as nodes. The branch and bound operations may prune, including pruning through backtracking, possible nodes of layer assignments to devices from the possible combinations. Such pruning may remove some decompositions into slices or improve efficiency in determining slices to deploy to devices 130 by reducing the number of nodes that the classifier 114 may have to explore.

In various embodiments, determining decomposition into slices may be based on a heuristic, which may be a target or past neural network split data. A target may be, for example, minimizing inference latency, maximizing throughput, minimizing power consumption, and/or a combination of the foregoing. Minimizing inference latency may include minimizing the time to execute slices across devices 130. Past neural network split data may include statistical information collected from past operations that may be used in operations described herein to speed up splitting a current neural network 200, including avoiding proposing some splits that would not achieve a target or may violate a constraint.

FIG. 6 illustrates an exemplary flowchart for determining slices in accordance with one or more embodiments of the present disclosure. The slices may be determined by performing a plurality of branch and bound operations. The branch and bound operations are described as operations associated with variables and domains to model the branch and bound operations as solving a CSOP. The layers 210 of a neural network 200 received may be the variables. The devices 130 may be the domains. The computation requirements of layers 210 may be targets (i.e., constraints) on the variables. The function to optimize may be a target.

The branch and bound operations of FIG. 6 may iterated for various assignments of variables to one or more domains, which may explore some or all of the set of possible assignments. The neural network splitter 110 may iterate through the branch and bound operations until an exit condition is satisfied for a particular assignment of variables to domains. All possible assignments of variables (e.g., layers) to domains (e.g., devices) constitute a search space comprised of a plurality of nodes that may be grouped into regions. Each region may have a root node. The nodes are each associated with a unique combination of how one or more layers 210 are assigned to one or more devices 130. A root node is a node associated with a particular assignment of one or more layers 210 assigned to a particular device 130. If the root node is determined to fail then the branches from that root node may be pruned and these branches do not need to be explored further by the branch and bound operations. By using a pruning operation, the branch and bound operations iterated are reduced for more efficient determination of slices, including in a shorter amount of time. Utilizing heuristics in one or more branch and bound operations for assignment of variables (e.g., layers) to domains (e.g., devices) may further result in optimal assignment of layers 210 to devices 130 while reducing complexity and the number of nodes explored to determine the slices.

At operation 602, it may be determined if all variables are assigned. All the variables (e.g., layers) must be assigned for a neural network 200 to be executed. If one or more variables (e.g., layers) are not assigned then one or more layers would not be included in the slices. If all the variables are assigned, proceed to operation 604. If one or more variables are not assigned, proceed to operation 616.

At operation 604, a feasible solution is found. A feasible solution may be a decomposition of a neural network 200 into slices including assignments to one or more devices 130 to achieve, for example, a target (e.g., latency, throughput, power consumption, etc.). As all the variables (e.g., layers) are assigned to one or more domains (e.g., devices), the solution is determined to be feasible.

At operation 606, an f-value is determined. The f-value is a value of the target for the current assignment of variables (e.g., layers) to domains (e.g., devices). For example, this may be the total inference latency. In another example, it may be the throughput.

At operation 608, if the f-value is better than a bound. If the variable assignments are an improvement over prior bound, proceed to operation 610. If the variable assignments are not an improvement over the current or prior bound, proceed to operation 612.

At operation 610, the assignments are saved and the current bound is updated to reflect the f-value of the current assignments saved.

At operation 612, backtracking is performed. Backtracking removes the last or prior assignment associated with the prior bound. The initial prior assignment is set to a negative infinite for a maximization, a positive infinite value for a minimization problem, and/or a minimum or maximum value representing a negative or positive infinite value.

At operation 614, if an exit condition is satisfied by the current assignments saved then branch and bound operations end. If the exit condition is not satisfied by the current assignments saved, proceed to operation 624. An exit condition may be if a root node is visited two times. A root node is a neural network decomposition of slices that may imply different further assignments to different devices 130. If the classifier 114 determines it is not capable to achieve the target at a root node then there is no need to progress further from this root node to other associated nodes.

At operation 616, an h-value is determined. The h-value may be a heuristic value, which may be based on one or more target(s). For example, if the target is to maximize a target (e.g., throughput), the h-value is an over-estimation of the f-value. If the target is to minimize a target (e.g., latency), the h-value is an under-estimation of the f-value.

At operation 618, determine if h-value is worse than the bound. If the h-value is worse, proceed to operation 622. If the h-value is better, proceed to operation 620.

At operation 620, current branch is pruned. Pruning may include pruning, cutting, deleting, or removing the region(s) of the possible domains that contain the current assignment(s).

At operation 622, new variable is selected. A new variable (e.g., layer) is selected to be assigned to a domain. A new variable (e.g., layer(s)) may be selected based on a target.

At operation 624, it is determined if all variables (e.g., layer) have been assigned. If all variables (e.g., layers) are assigned to a respective domain (e.g., device), proceed to operation 612. If all variables are not assigned to domains, proceed to operation 626.

At operation 626, variables (e.g., layers) are newly assigned to domains (i.e., device(s)). The new assignment of variables to domains is to another node of the search space not previously searched.

In various embodiments, the variables (e.g., layers) are assigned based on nodes associated from a domain (e.g., device) associated with a target. The heuristics may be used to improve performance of the determination of the slices. Examples of heuristics and assignment of variables to domains may include: privileging; sorting and assigning the devices by the highest/lowest clock frequency; sorting and assigning the devices by the highest/lowest FLASH size; sorting and assigning the devices by the highest/lowest RAM size; sorting and assigning the layers by the highest/lowest MACC; and/or a combination of such sorting and assignments. An example of a combination may be referred to as a “fail first approach” with a sorting of the layers by the highest RAM or FLASH size and the devices by the lowest RAM or FLASH size. Another example of a combination may be referred to as a “best device first” with sorting the devices by the highest clock frequency times the FLASH size.

At operation 628, determine if constraints are in conflict. The target or constraints described herein include constraints (i.e., targets), such as a device characteristics. It is determined if the layer(s) assigned to a device conflicts with (e.g., exceeds) available device characteristics. For example, it is determined if a required memory conflicts with the available memory of an assigned device. If constraints (i.e., targets) are not in conflict, proceed to operation 602. If constraints (i.e., targets) are not in conflict, proceed to operation 602.

An example of a constraint that may be in conflict is that the FLASH size of a currently assigned layers to a device (which is the sum of FLASH sizes needed by the layers) assigned to a device must be less than or equal to the FLASH size available on device.

Another example of a constraint that may be in conflict is that the RAM size of the currently assigned layers to a device must be less than or equal to the total RAM available on the assigned device.

### Exemplary Apparatus and Systems

Embodiments of the present disclosure herein include systems and apparatuses configured for and to perform one or more operations described herein.

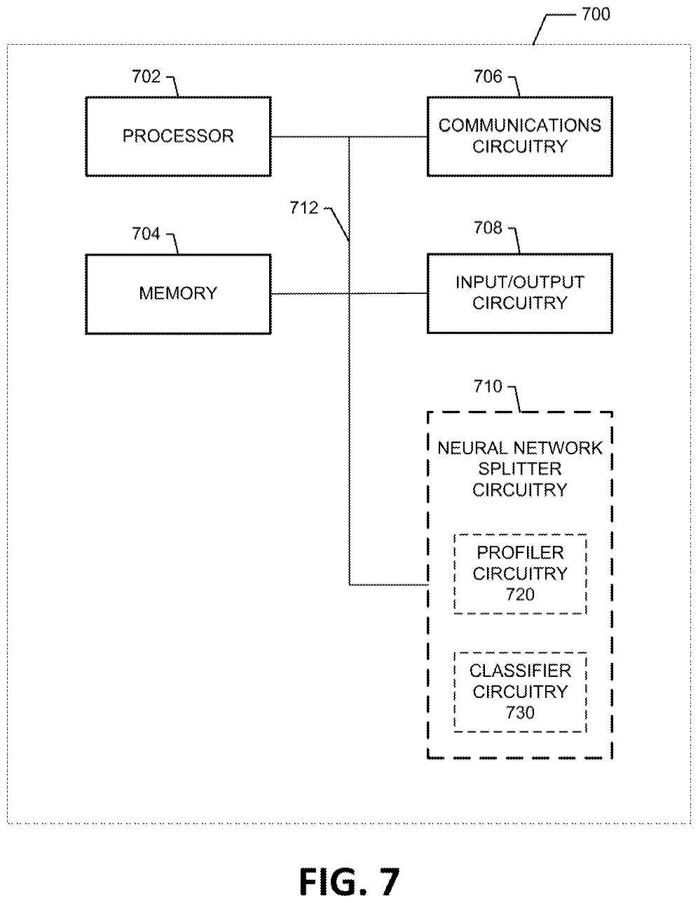

FIG. 7 illustrates an example block diagram of a device in accordance with one or more embodiments of the present disclosure. Exemplary embodiments of the device 700 may include, for example, servers, computers, mobile devices, smart watches, sensors, etc. Additionally or alternatively, the device 700 may be a splitter device 130A, one of the connected devices 130B-130E, and/or a server 140. The device 700 illustrated includes a processor 702, memory 704, communications circuitry 706, and input/output circuitry 708, and neural network splitter circuitry 710 (a.k.a., splitter circuitry), which may all be connected via a bus 712. The splitter circuitry 710 may include profiler circuitry 720 and/or classifier circuitry 730.

The processor 702, although illustrated as a single block, may be comprised of a plurality of components and/or processor circuitry. The processor 702 may be implemented as, for example, various components comprising one or a plurality of microprocessors with accompanying digital signal processors; one or a plurality of processors without accompanying digital signal processors; one or a plurality of coprocessors; one or a plurality of multi-core processors; processing circuits; and various other processing elements. The processor may include integrated circuits, such as ASICs, FPGAs, systems-on-a-chip (SoC), or combinations thereof. In various embodiments, the processor 702 may be configured to execute applications, instructions, and/or programs stored in the processor 702, memory 704, or otherwise accessible to the processor 702. When executed by the processor 702, these applications, instructions, and/or programs may enable the execution of one or a plurality of the operations and/or functions described herein. Regardless of whether it is configured by hardware, firmware/software methods, or a combination thereof, the processor 702 may comprise entities capable of executing operations and/or functions according to the embodiments of the present disclosure when correspondingly configured.

The memory 704 may comprise, for example, a volatile memory (e.g., RAM), a non-volatile memory (e.g., ROM), or a certain combination thereof. Although illustrated as a single block, the memory 704 may comprise a plurality of memory components. In various embodiments, the memory 704 may comprise, for example, a random access memory, a cache memory, a flash memory, a hard disk, a circuit configured to store information, or a combination thereof. The memory 704 may be configured to write or store data, information, application programs, instructions, etc. so that the processor 702 may execute various operations and/or functions according to the embodiments of the present disclosure. For example, in at least some embodiments, a memory 704 may be configured to buffer or cache data for processing by the processor 702. Additionally or alternatively, in at least some embodiments, the memory 704 may be configured to store program instructions for execution by the processor 702. The memory 704 may store information in the form of static and/or dynamic information. When the operations and/or functions are executed, the stored information may be stored and/or used by the processor 702.

The communication circuitry 706 may be implemented as a circuit, hardware, computer program product, or a combination thereof, which is configured to receive and/or transmit data from/to another component or apparatus. The computer program product may comprise computer-readable program instructions stored on a computer-readable medium (e.g., memory 704) and executed by a processor 702. In various embodiments, the communication circuitry 706 (as with other components discussed herein) may be at least partially implemented as part of the processor 702 or otherwise controlled by the processor 702. The communication circuitry 706 may communicate with the processor 702, for example, through a bus 712. Such a bus 712 may connect to the processor 702, and it may also connect to one or more other components of the processor 702. The communication circuitry 706 may be comprised of, for example, transmitters, receivers, transceivers, network interface cards and/or supporting hardware and/or firmware/software, and may be used for establishing communication with another device(s), component(s), apparatus(es), and/or system(s). The communication circuitry 706 may be configured to receive and/or transmit data that may be stored by, for example, the memory 704 by using one or more protocols that can be used for communication between components, apparatuses, and/or systems.

In various embodiments, the communication circuitry 706 may convert, transform, and/or package data into data packets and/or data objects to be transmitted, converted, transformed, and/or unpackaged when received, such as from a first protocol to a second protocol, from a first data type to a second data type, from an analog signal to a digital signal, from a digital signal to an analog signal, or the like. The communication circuitry 706 may additionally, or alternatively, communicate with the processor 702, the memory 704, the input/output circuitry 708, and/or the neural network splitter circuitry 710, such as through a bus 712.

The input/output circuitry 708 may communicate with the processor 702 to receive instructions input by an operator and/or to provide audible, visual, mechanical, or other outputs to an operator. The input/output circuitry 708 may comprise supporting devices, such as a keyboard, a mouse, a user interface, a display, a touch screen display, lights (e.g., warning lights), indicators, speakers, and/or other input/output mechanisms. The input/output circuitry 708 may comprise one or more interfaces to which supporting devices may be connected. In various embodiments, aspects of the input/output circuitry 708 may be implemented on a device used by the operator to communicate with the processor 702. The input/output circuitry 708 may communicate with the memory 704, the communication circuitry 706, the neural network splitter circuitry 710, and/or any other component, for example, through a bus 712.

The neural network splitter circuitry 710 may be implemented as any apparatus included in a circuit, hardware, computer program product, or a combination thereof, which is configured to perform one or more splitter operations and/or functions, such as those described herein. The neural network splitter circuitry 710 may include the splitter 110, profiler circuitry 720, and classifier circuitry 730 as well as other circuitry, apparatuses, and/or components for performing operations and/or functions described herein. The neural network splitter circuitry 710 may include the splitter 110 and/or computer-readable program instructions for splitter operations and/or functions stored on a computer-readable medium (e.g., memory 704) and executed by a processor 702. In various embodiments, the neural network splitter circuitry 710 may be at least partially implemented as part of the processor 702 or otherwise controlled by the processor 702. The profiler circuitry 720 may include the profiler 112 and additional circuitry required to perform operations and/or functions associated with the profiler 112, including circuitry for communicating with one or more other portions of a device 700. The classifier circuitry 730 may include the classifier 114 and additional circuitry required to perform operations and/or functions associated with the classifier 114, including circuitry for communicating with one or more other portions of a device 700. The neural network splitter circuitry 710, profiler circuitry 720, and classifier circuitry 730, may communicate with the processor 702, for example, through a bus 712.

In various embodiments, the device 700 of FIG. 7 may be representative of a splitter device 130A, a connected device 130B-130E, and/or a server 140. Alternatively or additionally, a device 700 may be included in a system and/or a device that includes one or more components of FIG. 7 as well as additional components not illustrated.

### CONCLUSION

Operations and/or functions of the present disclosure have been described herein, such as in flowcharts. As will be appreciated, computer program instructions may be loaded onto a computer or other programmable apparatus (e.g., hardware) to produce a machine, such that the resulting computer or other programmable apparatus implements the operations and/or functions described in the flowchart blocks herein. These computer program instructions may also be stored in a computer-readable memory that may direct a computer, processor, or other programmable apparatus to operate and/or function in a particular manner, such that the instructions stored in the computer-readable memory produce an article of manufacture, the execution of which implements the operations and/or functions described in the flowchart blocks. The computer program instructions may also be loaded onto a computer, processor, or other programmable apparatus to cause a series of operations to be performed on the computer, processor, or other programmable apparatus to produce a computer-implemented process such that the instructions executed on the computer, processor, or other programmable apparatus provide operations for implementing the functions and/or operations specified in the flowchart blocks. The flowchart blocks support combinations of means for performing the specified operations and/or functions and combinations of operations and/or functions for performing the specified operations and/or functions. It will be understood that one or more blocks of the flowcharts, and combinations of blocks in the flowcharts, can be implemented by special purpose hardware-based computer systems which perform the specified operations and/or functions, or combinations of special purpose hardware with computer instructions.

While this specification contains many specific embodiments and implementation details, these should not be construed as limitations on the scope of any disclosures or of what may be claimed, but rather as descriptions of features specific to particular embodiments of particular disclosures. Certain features that are described herein in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

While operations and/or functions are illustrated in the drawings in a particular order, this should not be understood as requiring that such operations and/or functions be performed in the particular order shown or in sequential order, or that all illustrated operations be performed, to achieve desirable results. In certain circumstances, operations and/or functions in alternative ordering may be advantageous. In some cases, the actions recited in the claims may be performed in a different order and still achieve desirable results. Thus, while particular embodiments of the subject matter have been described, other embodiments are within the scope of the following claims.

While this detailed description has set forth some embodiments of the present invention, the appended claims cover other embodiments of the present invention which differ from the described embodiments according to various modifications and improvements.

Within the appended claims, unless the specific term “means for” or “step for” is used within a given claim, it is not intended that the claim be interpreted under 35 U.S.C. § 112, paragraph 6.

1. A method comprising:
generating an intermediate representation of a neural network, wherein the neural network is comprised of a plurality of layers;
extracting, via a profiler of a splitter device, a plurality of neural network features based on the intermediate representation;
selecting, via a classifier of the splitter device, one or more heuristics based on the neural network features;
determining one or more device characteristics of the one or more devices, wherein the one or more devices are connected to the splitter device;
determining a plurality of slices based on the neural network features, the one or more heuristics and the device characteristics, wherein each slice of the plurality of slices is associated with at least one of the devices, and wherein each of the plurality of slices is associated with one or more of the plurality of layers; and
generating the plurality of slices.

2. The method of claim 1 further comprising:
transmitting each of the plurality of slices to the associated device of the one or more devices.

3. The method of claim 1, wherein the classifier is comprised of a classifier neural network.

4. The method of claim 1, wherein determining one or more device characteristics of the one or more devices comprising:
querying the one or more connected devices; and
receiving, based on the query, the device characteristics.

5. The method of claim 1, wherein the one or more devices are heterogenous devices.

6. The method of claim 1, wherein the one or more heuristics includes minimizing a latency.

7. The method of claim 1, wherein the one or more heuristics includes maximizing a throughput.

8. The method of claim 1, wherein each slice of the plurality of slices is associated with only one device.

9. The method of claim 1, wherein at least two of the slices of the plurality of slices are associated with a first device of the one or more devices.

10. The method of claim 1, wherein the slices are comprised of instructions for transmitting results associated with an execution of slice to a subsequent device.

11. A splitter device comprising:
at least one processor and at least one memory coupled to the processor, wherein the processor is configured to:
generate an intermediate representation of a neural network, wherein the neural network is comprised of a plurality of layers;
extract, via a profiler of the splitter device, a plurality of neural network features based on the intermediate representation;
select, via a classifier of the splitter device, one or more heuristics based on the neural network features;
determine one or more device characteristics of the one or more devices, wherein the one or more devices are connected to the splitter device;
determine a plurality of slices based on the neural network features, the one or more heuristics and the device characteristics, wherein each slice of the plurality of slices is associated with at least one of the devices, and wherein each of the plurality of slices is associated with one or more of the plurality of layers; and
generate the plurality of slices.

12. The apparatus of claim 11, wherein the processor is further configured to:
transmit each of the plurality of slices to the associated device of the one or more devices.

13. The apparatus of claim 11, wherein the classifier is comprised of a classifier neural network.

14. The apparatus of claim 11, wherein determine one or more device characteristics of the one or more devices the processor is further configured to:
query the one or more connected devices; and
receive, based on the query, the device characteristics.

15. The apparatus of claim 11, wherein the one or more devices are heterogenous devices.

16. The apparatus of claim 11, wherein the one or more heuristics includes minimizing a latency.

17. The apparatus of claim 11, wherein the one or more heuristics includes maximizing a throughput.

18. The apparatus of claim 11, wherein each slice of the plurality of slices is associated with only one device.

19. The apparatus of claim 11, wherein at least two of the slices of the plurality of slices are associated with a first device of the one or more devices.

20. The apparatus of claim 11, wherein the slices are comprised of instructions for transmitting results associated with an execution of slice to a subsequent device.
